(19) United States
(12) Patent Application Publication
(10) Pub. No.: US 2014/0330513 A1
(43) Pub. Date: Nov. 6, 2014

(54) Linear and Radial Legend Based on Motion

(71) Applicants: Roger A. Fratti, Mohnton, PA (US); Arlen Martin, Blandon, PA (US)

(72) Inventors: Roger A. Fratti, Mohnton, PA (US); Arlen Martin, Blandon, PA (US)

(21) Appl. No.: 13/888,762

(22) Filed: May 7, 2013

Related U.S. Application Data
(60) Provisional application No. 61/818,022, filed on May 1, 2013.

(51) Int. Cl. G01C 21/26

(52) U.S. Cl. CPC G01C 21/26
USPC 701/455

(57) ABSTRACT

The present disclosure is directed to a method for indicating a direction of motion and a scale on a map. The method includes the step of detecting a position, a speed, and a direction of motion. The method also includes the step of calculating a vector based on the position, speed, and direction of motion, the vector including a scale. A further step of the method includes overlaying the vector on the position indicator on the map.

### PRIORITY

The present application claims the benefit under 35 U.S.C. §119(e) of U.S. Provisional Application Ser. No. 61/818,022, filed May 1, 2013, which is incorporated herein by reference.

### FIELD OF THE INVENTION

The present disclosure is directed generally towards the use of scales in mapping applications.

### BACKGROUND

Existing systems and methods for mapping and navigation may not provide desired features. For example, existing legends provided on the maps may be located in a corner of the map display and include limited information.

Therefore, there exists a need for improved methods and systems for providing a linear and radial legend based on motion.

### SUMMARY

The present disclosure is directed to a method for indicating a direction of motion and a scale on a map. The method includes the step of detecting a position, a speed, and a direction of motion. The method also includes the step of calculating a vector based on the position, speed, and direction of motion, the vector including a scale. A further step of the method includes overlaying the vector on the position indicator on the map.

Additional embodiments are described in the application including the claims. It is to be understood that both the foregoing general description and the following detailed description are exemplary and explanatory only and are not restrictive. Other embodiments of the invention will become apparent.

### BRIEF DESCRIPTION OF THE FIGURES

Other embodiments of the invention will become apparent by reference to the accompanying figures in which:

FIG. 1 shows a flow diagram of a method for indicating a direction of motion and a scale on a map;

FIG. 2 shows an example of a vector overlaid on a position indicator of a map;

FIG. 3 shows an example of a vector overlaid on a position indicator of a map, the vector including a time scale;

FIG. 4 shows a flow diagram of a method for providing a legend on a map;

FIG. 5 shows an example of a legend including concentric circles overlaid on a position indicator of a map;

FIG. 6 shows an example of a legend including closed concentric curves overlaid on a position indicator of a map; and

FIG. 7 shows a diagrammatic representation of a system for indicating a direction of motion and a scale on a map.

### DETAILED DESCRIPTION

Reference will now be made in detail to the subject matter disclosed, which is illustrated in the accompanying drawings. The scope of embodiments of the invention is limited only by the claims; numerous alternatives, modifications, and equivalents are encompassed. For the purpose of clarity, technical material that is known in the technical fields related to the embodiments has not been described in detail to avoid unnecessarily obscuring the description.

Existing systems and methods for mapping and navigation may not provide desired features. For example, existing legends in mapping applications may place the legend in a corner of the map. The legend is static and does not change dynamically in response to changes in speed or direction. Similarly, existing legends do not clearly correlate to the direction or route the user is taking.

For example, when sitting in traffic and looking at a smart phone based mapping application, a user may look at a mapping application to see how far into the distance a traffic jam will last. The mapping application displays the traffic, but it can be difficult to predict how far ahead (in time or in distance) the traffic extends because there is no scale, or the scale is located in a corner of the map display. In cases where there is a legend on the map, the legend is not correlated to the current location on the route and it is up to the user to estimate the distance between the user's current position and a destination.

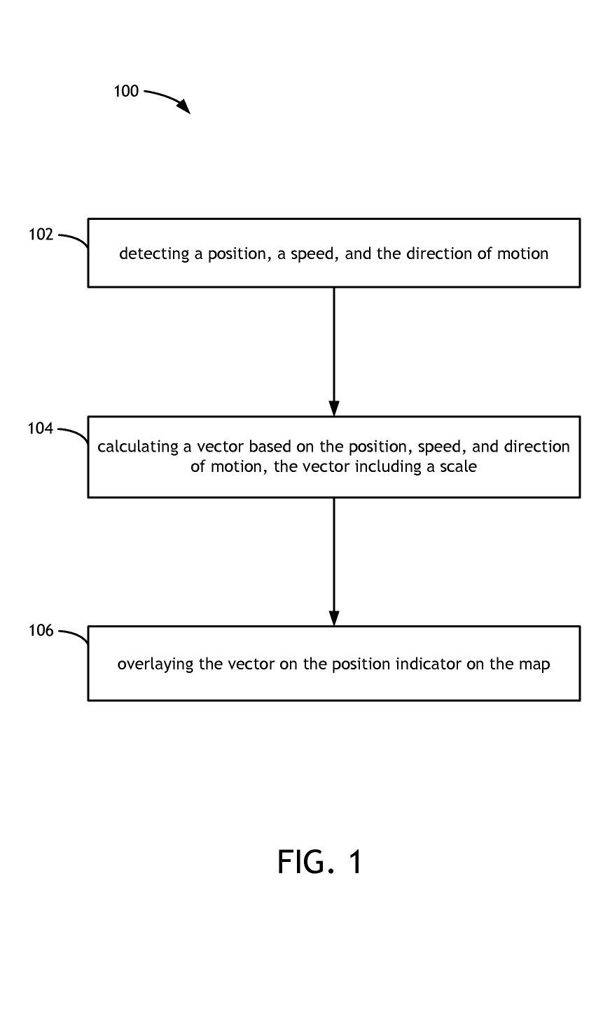

The present disclosure is directed to a linear and radial scale based on motion that provides a measure of distance, time, or both. Referring generally to FIG. 1, a method 100 for indicating a direction of motion and a scale on a map is provided. The method 100 includes the step of detecting a position, a speed, and the direction of motion 102. The method 100 also includes the step of calculating a vector based on the position, speed, and direction of motion, the vector including a scale 104. The method 100 also includes the step of overlaying the vector on a position indicator on the map 106.

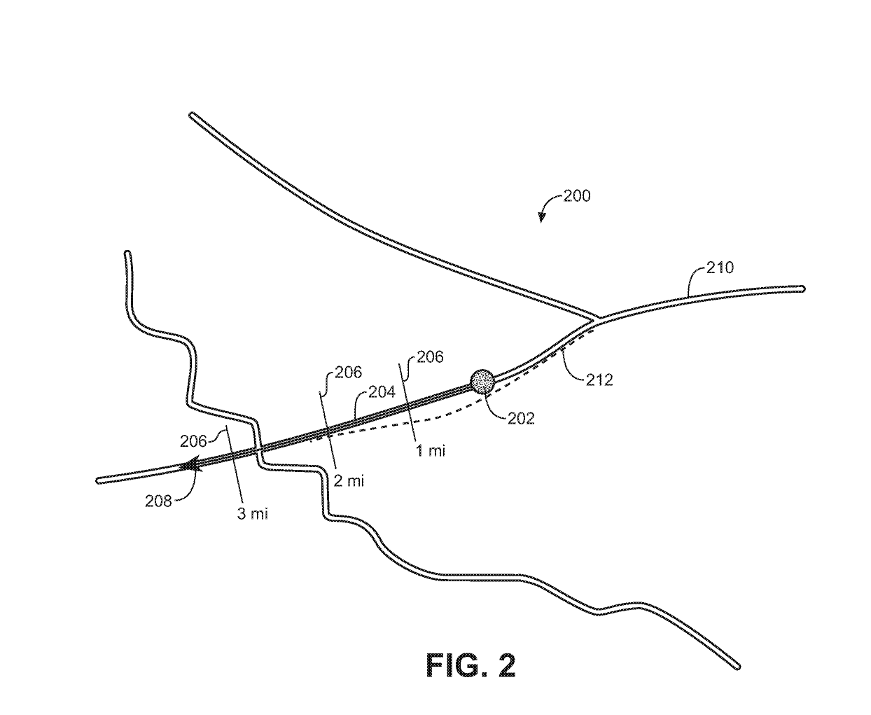

An example implementation of the radial scale 200 provided using the method 100 is provided in FIG. 2. In one embodiment, the map includes a position indicator 202. The vector 204 is overlaid on the position indicator 202, such that one end of the vector 204 contacts the position indicator 202. The vector 204 also includes a scale. In the embodiment shown in FIG. 2, the scale includes several increments 206 indicating distance. For example, in the embodiment shown in FIG. 2, the scale includes one mile increments 206. The vector 204 also includes an arrow 208 indicating a direction of motion.

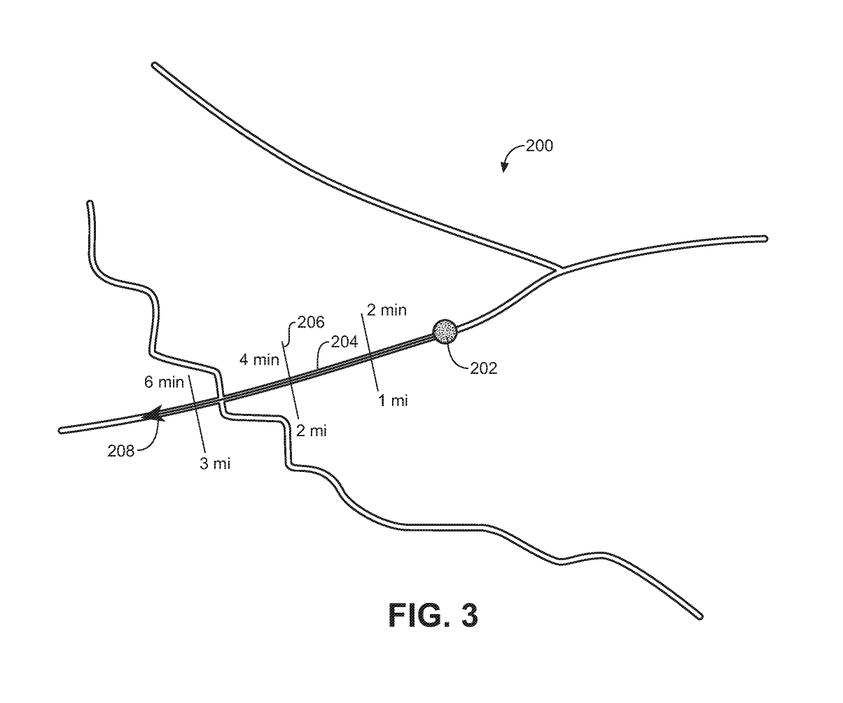

In the embodiment shown in FIG. 2, the scale on the vector 204 shows the distance between the current position indicator 202 and the distance increments 206 in the current direction of motion. In another embodiment, the scale on the vector 204 is displayed in a unit of time, such as minutes. The time displayed is based on the current speed, and indicates the amount of time required to traverse the distance shown by the increments 206 on the scale of vector 204, assuming the system maintains its current speed. In another embodiment shown in FIG. 3, the scale on the vector 204 displays both the amount of time required to traverse the distance shown by the vector 204, as well as the corresponding distance. In the embodiment shown in FIG. 3, the amount of time required to travel the distance of 1 mile is two minutes, the time required to reach the two mile increment is 4 minutes, and the time required to reach the three mile increment is 6 minutes.

The units of the scale are adjustable and are selected by a user in one embodiment. In another embodiment, the units on the scale are selected automatically based on the speed, direction of motion, and current location. For example, if the current speed is walking speed (between 0 and 5 miles per hour), the scale is displayed on the order of feet and city blocks. If the current speed is driving speed (for example, above 10 miles per hour), the scale is displayed on the order of approximately one mile in one embodiment. The foregoing descriptions are merely exemplary and not intended to limit the scope of the present disclosure, and it is understood that the scale is not limited to a particular unit or distance measurement, and is adjustable according to the circumstances. In one embodiment, the units are metric units. In another embodiment, the units are United States Customary Units. Any appropriate unit system may be used to depict the distances or time on the scale.

The vector 204 shown in FIGS. 2 and 3 is overlaid on the position indicator 202 in one embodiment. In another embodiment, the vector 204 is placed adjacent to the position indicator 202. In another embodiment, the vector 204 floats over the position indicator 202. In another embodiment, the placement of the vector 204 relative to the position indicator or relative to the boundaries of the map is adjustable by a user.

The method 100 shown in FIG. 1 includes additional steps in one embodiment. The method 100 further includes the step of detecting a change in one of the position, the speed, and the direction of motion. The method 100 also includes the step of calculating an updated vector based on at least a current position, a current speed, and a current direction of motion, the vector including a scale. An additional step of the method includes overlaying the updated vector on the position indicator on the map. The additional steps of the method 100 provide the advantage of updating the vector dynamically in response to any one of a change in position, speed, or direction of motion. A change in the vector also includes updating the scale included with the vector. For example, if the system has reduced its speed, the scale of the vector is “zoomed in” or reduced in order to provide a more useful measurement of distance or time required to travel the distance indicated. Similarly, if the object has increased its speed, the scale may be increased or “zoomed out”.

In one embodiment, the method 100 is performed continuously with dynamic detection of any changes in position, direction, or speed. The placement, direction, and scale of the vector changes dynamically to adapt to such changes. In another embodiment, the method 100 is performed incrementally at regular time intervals to adjust the vector and the scale.

In one embodiment, the step of calculating a vector based on the position, speed, and direction of motion 104 of the method 100 includes calculating the vector based on at least one additional factor. The at least one additional factor includes factors such as traffic information, weather information, and road condition information, or the like. For example, when the scale includes a time estimate for the time required to travel the distance on the map indicated by the length of the vector, the time estimate accounts for traffic information on the intended route. Thus, if there is traffic on the road up ahead, the time estimates provided on the scale will account for the current speed as well as the traffic conditions and any resulting delay. In one embodiment, the traffic condition information is derived from a crowd sourcing application that provides information from one or more users about road conditions on the route. Road conditions may include any information about the road such as accidents, obstructions, lane restrictions, carpooling lanes, closures, construction, and the like.

The vector displayed on the map in FIG. 2 is useful in determining how far along the route traffic extends in one embodiment. For example, a feature of an existing mapping application provides traffic information along the route, typically via a colored, bold, or dotted line. In one embodiment, the vector 200 is displayed along with the traffic information. The vector 200 is then used to estimate how far into the distance the traffic condition extends. FIG. 2 shows a current route 210 and a dotted line 212 indicating the extent of a traffic delay. By placing the vector 200 on the position indicator 202, it is possible to determine that the traffic delay 212 extends slightly more than two miles up ahead in the example provided.

The step of detecting a position, a speed, and the direction of motion 102 of the method 100 is completed using any suitable system. In one embodiment, this includes a global positioning system, an accelerometer, a cellular network, a Wi-Fi network, or a combination of these systems.

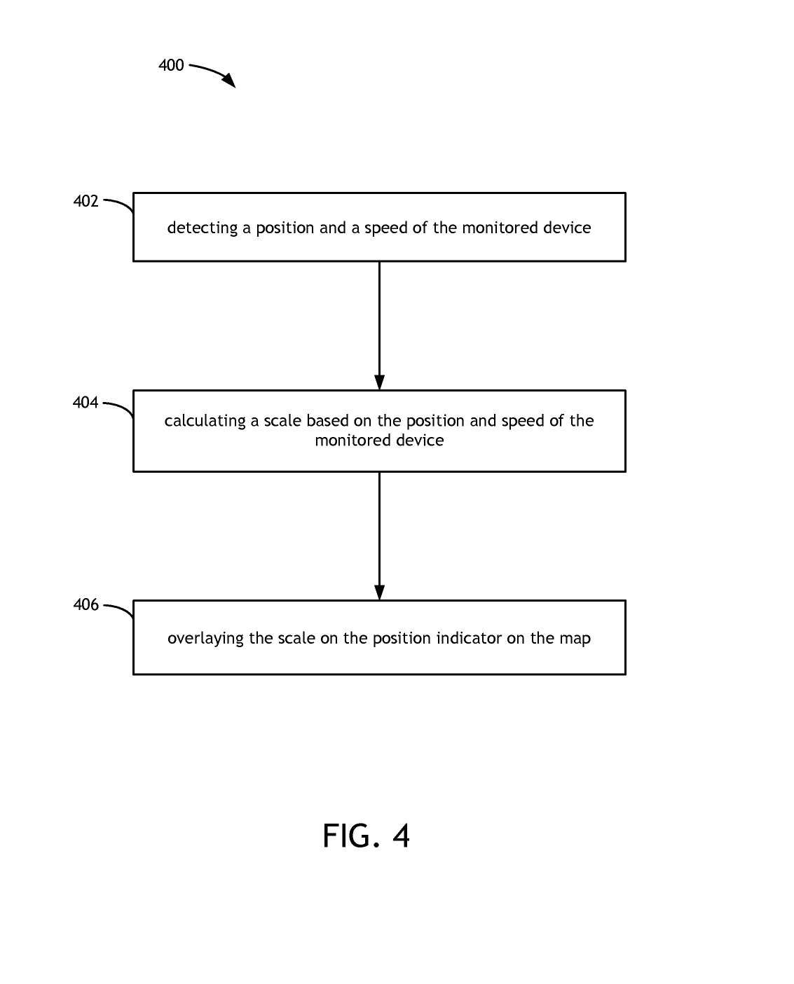

The present disclosure is also directed to the method 400 shown in FIG. 4. The method 400 is used to provide a legend on a map, the map including a position indicator of a monitored device. The method 400 includes the step of detecting a position and a speed of the monitored device 402. The method 400 also includes the step of calculating a scale based on the position and speed of the monitored device 404. The method 400 also includes the step of overlaying the scale on the position indicator on the map 406.

In one embodiment, the method 400 is implemented on the monitored device, which may include a phone, GPS, navigation system, or other similar device. In another embodiment, the method 400 is implemented on a separate system used to track the monitored device.

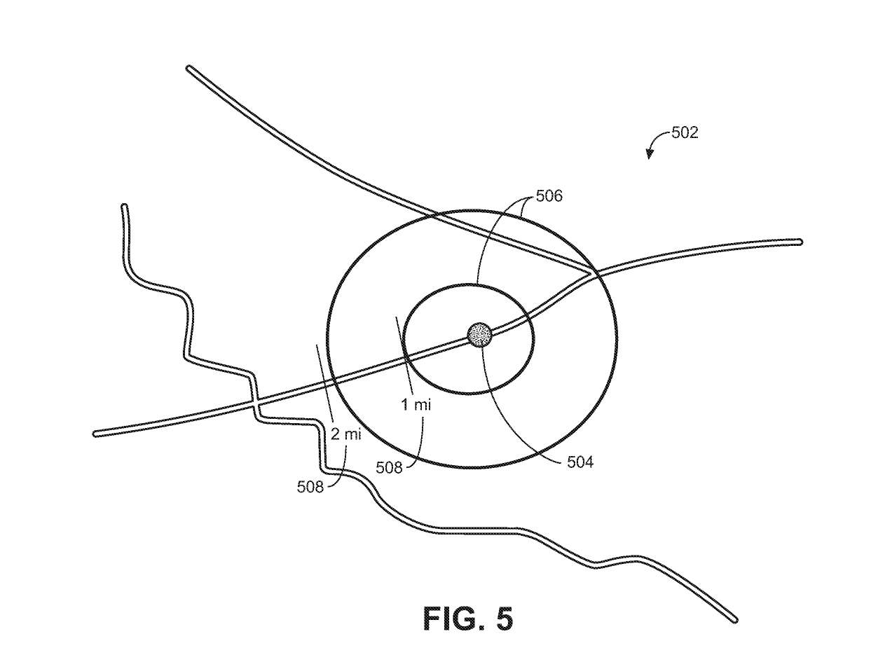

In one embodiment, a plurality of concentric circles are used to illustrate the legend determined using the method 400, as shown in FIG. 5. The legend 502 is overlaid on the position indicator 504, and the scale includes a plurality of concentric circles 506. Each concentric circle 506 includes distance information in one embodiment. For example, in the embodiment shown in FIG. 5, the first concentric circle 506 includes a label 508 indicating that the distance between the position indicator 504 and the first concentric circle 506 is 1 mile. The next concentric circle 506 includes a label 508 showing a distance of 2 miles. In another embodiment, the units on the concentric circles 508 include time units based on an estimate of the amount of time required to travel the distance between the current position shown by the position indicator 504 and each the concentric circle 506 based on the current speed of the monitored device. In another embodiment, each concentric circle 506 includes a label 508 displaying both time and distance.

In one embodiment, the number of concentric circles 506 varies depending on the location and speed. In another embodiment, a user selects a desired scale for the concentric circles 506.

One benefit of using the concentric circle legend provided in FIG. 5 is a user may be considering a change in direction. The concentric circles 506 provide a legend for the distance or time to travel in a direction that differs from the current direction of motion.

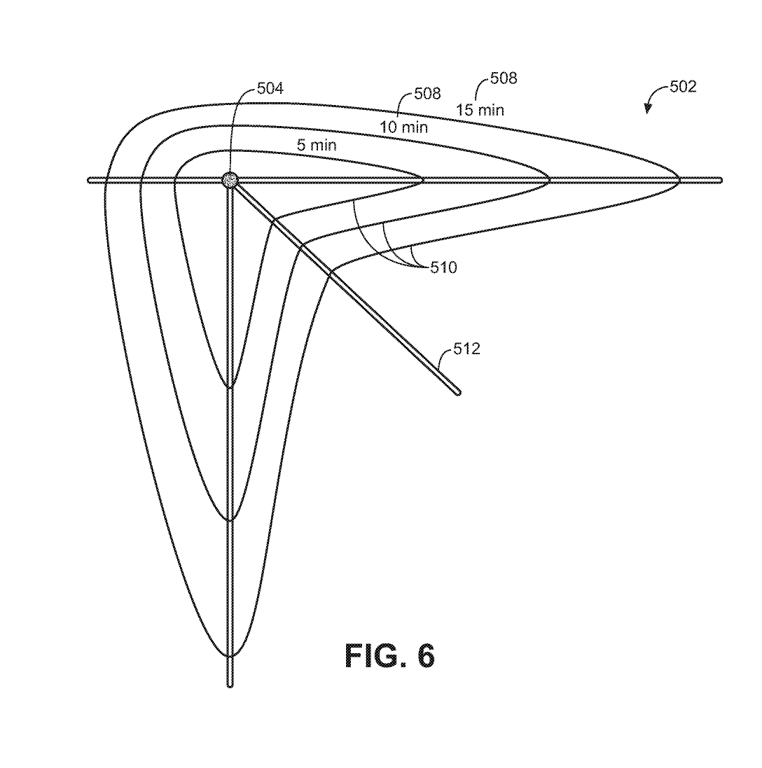

In another embodiment shown in FIG. 6, a plurality of concentric closed curves 510 depict the legend determined using the method 400. In the embodiment shown in FIG. 6, the scale 502 is calculated based on the position and speed of the monitored device, as well as at least one additional factor. The at least one additional factor includes at least one of traffic information, weather information, road condition information, or any other factor relevant to the time required to travel nearby routes, such as topographic information for example. The scale 502 accounts for the position, speed, and at least one additional factor by adjusting the dimensions of each concentric closed curve 510 based on the at least one additional factor. For example, when the scale 502 is adjusted based on traffic information along the current route and adjacent routes, the concentric closed curves 510 are elongated along the route that has more traffic to show the travel time along that route will be longer. Similarly, the concentric closed curves 510 are contracted along routes that have less traffic. This allows a user to examine the scale 502 and the plurality of concentric closed curves 510 to determine the fastest route. In the example shown in FIG. 6, the fastest route is along the road 512, as the concentric closed curves 510 along that route are the closest together. In one embodiment, the fastest route is highlighted or identified on the map to aid a user in identifying the fastest route.

In one embodiment, the concentric circle legend provided in FIGS. 5 and 6 and the vector based legend provided in FIGS. 2-3 are configured to move with the position indicator, and to update dynamically as the position indicator moves.

The method 100 shown in FIG. 1 and the method 400 shown in FIG. 4 are implemented by an application on a computing device in one embodiment. The computing device may include a cell phone, a laptop computer, a tablet computer, a personal computer, a PDA, an e-reading device, or a navigation system. The forgoing list is merely exemplary and the scope of devices on which the methods may be implemented is not intended to be limited to the examples described. Any device using a mapping function may implement the method 100 and the method 400. The methods of the present disclosure are also suitable for use in conjunction with cloud applications in one embodiment. For example, information such as traffic, road, mapping, weather, and route information may be processed in a cloud computing application and then communicated to an application implementing the method.

The method 100 shown in FIG. 1 and the method 400 shown in FIG. 4 are used to indicate a distance between a current position and different locations in one embodiment. For example, the method 100 is used to display with a vector the distance required between a current position and a desired or suggested location, such as a restaurant, retail store, landmark, or the like. The method 400 is used to display a distance between a current position and a desired or suggested location via the concentric circles displaying the distances between the current position and one or more other locations.

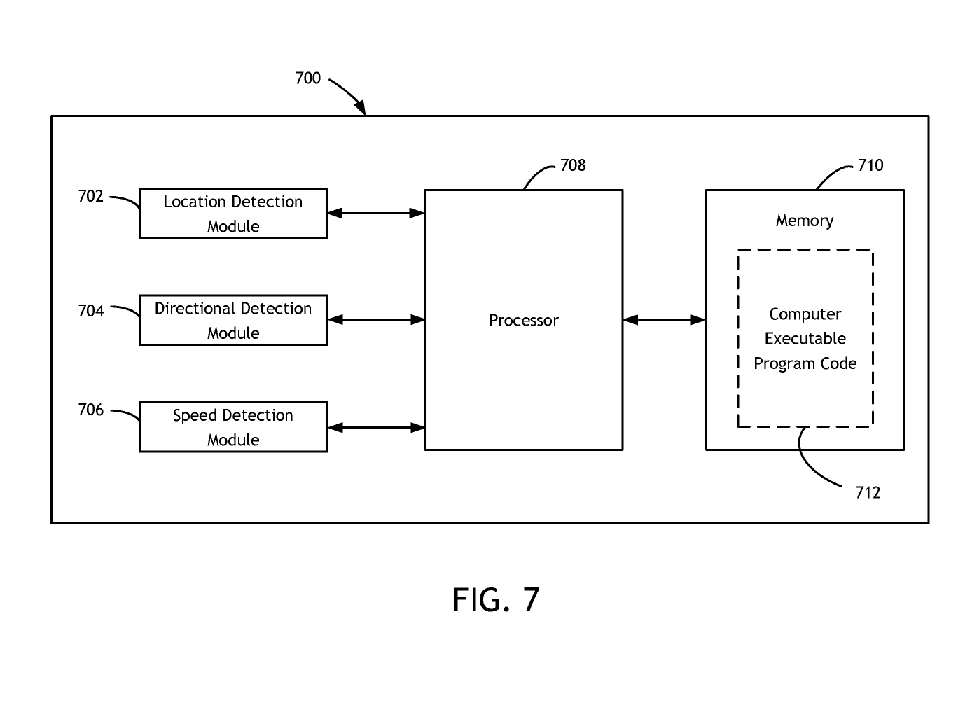

The present disclosure is also directed to a system 700 as shown in FIG. 7. The system 700 is used for providing a legend on a map, the map including a position indicator for highlighting the location of the system 700. The system 700 includes a location detection module 702. The location detection module 702 is configured to determine a position of the system 700 and to detect a change in position of the system 700. The system 700 also includes a directional detection module 704 configured to determine a direction of movement of the system 700 and a speed detection module 706 configured to measure a speed of the system 700. The location detection module 702, directional detection module 704, and speed detection module 706 are all in communication with a processor 708. The processor 708 is configured to calculate a vector based on the position, speed, and direction of motion of the system 700. The vector includes a scale. The processor 708 is further configured to overlay the vector on a position indicator on the map. The processor 708 is also in communication with a memory 710. The memory 710 is configured for storing a computer executable program code 712 configured to execute on the processor 708.

In one embodiment, the processor 708 shown in FIG. 7 is also configured to calculate an updated vector when a change in at least one of the position, the speed, and the direction of motion of the system 700 is detected. The processor 708 is also configured to overlay the updated vector on the position indicator on the map. In another embodiment, the processor 708 is also configured to receive traffic information, weather information, or road condition information, and to use this information to calculate an updated vector.

The system and methods of the present disclosure provide several advantages. For example, the system and methods of the present disclosure provide a dynamic visual legend to aid a user in estimating the scope of a traffic jam, or the distance between the user's current location and a desired location. The visual legend provides this information dynamically, taking into account traffic and road conditions and updating continuously. Similarly, the scale of the legend or vector provided in the system and methods of the present disclosure is adjustable and updates dynamically in response to changes in speed, direction, a user selection, or other conditions. All of these features provide the benefit of aiding a user in estimating the time or distance required to traverse a distance on a map.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for providing a legend on a map, the map including a position indicator of a monitored device, the method comprising:
detecting a position and a speed of the monitored device;
calculating a scale based on the position and speed of the monitored device; and
overlaying the scale on the position indicator on the map.

2. The method as claimed in claim 1, wherein the scale includes at least one of: a distance scale and a time scale.

3. The method as claimed in claim 1, further comprising:
detecting a change in at least one of the position and the speed of the monitored device;
calculating an updated scale based on at least a current position and a current speed of the monitored device; and
overlaying the updated scale on the position indicator on the map.

4. The method as claimed in claim 1, wherein the detecting a position and a speed of the monitored device includes detecting a position and a speed of the monitored device using at least one of: a global positioning system, an accelerometer, a cellular network, or a Wi-Fi network.

5. The method as claimed in claim 1, wherein the scale includes a plurality of concentric circles.

6. The method as claimed in claim 1 wherein the calculating a scale based on the position and speed of the object further includes:
calculating a scale based on at least one of: traffic information, weather information, and road condition information.

7. The method as claimed in claim 6, wherein the scale includes a plurality of concentric closed curves.

8. The method as claimed in claim 7, wherein a dimension of each concentric closed curve is adjusted based on the at least one of: traffic information, weather information, and road condition information.

9. A method for indicating a direction of motion and a scale on a map, the map including a position indicator, the method comprising:
detecting a position, a speed, and the direction of motion;
calculating a vector based on the position, speed, and direction of motion, the vector including a scale; and
overlaying the vector on the position indicator on the map.

10. The method as claimed in claim 9, wherein the scale includes a distance scale.

11. The method as claimed in claim 9, wherein the scale includes a time scale.

12. The method as claimed in claim 9, further comprising:
detecting a change in at least one of the position, the speed, and the direction of motion;
calculating an updated vector based on at least a current position, a current speed, and a current direction of motion, the vector including a scale; and
overlaying the updated vector on the position indicator on the map.

13. The method as claimed in claim 9 wherein the calculating a vector based on at least the position, speed, and direction of motion further includes:
calculating a vector based on at least one of: traffic information, weather information, and road condition information.

14. The method as claimed in claim 9, wherein a unit of measurement of the scale is based on the speed.

15. The method as claimed in claim 9, wherein a unit of measurement of the scale is based on a user selection.

16. A computer-readable device having computer-executable instructions for performing a method for indicating a direction of motion and a scale on a map, the map including a position indicator, the instructions comprising:
detecting a position, a speed, and the direction of motion;
calculating a vector based on the position, speed, and direction of motion, the vector including a scale; and
overlaying the vector on the position indicator on the map.

17. The device as claimed in claim 16, wherein the scale includes a distance scale.

18. The device as claimed in claim 16, wherein the scale includes a time scale.

19. The device as claimed in claim 16, wherein the instructions further comprise:
detecting a change in at least one of the position, the speed, and the direction of motion;
calculating an updated vector based on at least a current position, a current speed, and a current direction of motion, the vector including a scale; and
overlaying the updated vector on the position indicator on the map.

20. The device as claimed in claim 16, wherein the calculating a vector based on at least the position, speed, and direction of motion further comprises:
calculating a vector based on at least one of: traffic information, weather information, and road condition information.
